(19) United States
(12) Patent Application Publication
(10) Pub. No.: US 2014/0271990 A1
(43) Pub. Date: Sep. 18, 2014

(54) COMPOSITIONS AND METHOD OF PRESERVING MUSCLE TISSUE

(71) Applicant: Wisconsin Alumni Research Foundation, Madison, WI (US)

(72) Inventors: Mark Richards, Madison, WI (US); Eric Grunwald, Madison, WI (US)

(73) Assignee: Wisconsin Alumni Research Foundation, Madison, WI (US)

(21) Appl. No.: 14/204,477

(22) Filed: Mar. 11, 2014

Related U.S. Application Data
(60) Provisional application No. 61/777,864, filed on Mar. 12, 2013.

(51) Int. Cl. A23B 4/22

(52) U.S. Cl. CPC A23B 4/22
USPC 426/56; 426/7

(57) ABSTRACT

The invention provides for compositions and methods for the preservation of meat tissues, including fish, beef, poultry and pork us phospholipase A2 (PLA2) enzymes.

This application claims benefit of priority to U.S. Provisional Application Ser. No. 61/777,864, filed Mar. 12, 2013, the entire contents of which are hereby incorporated by reference.

### BACKGROUND OF THE INVENTION

1. Field of the Invention

This invention relates to composition and methods for the preservation of meat products including fish, fowl and red meat. In particular, phospholipase A2 enzymes are used at very low concentrations to reduct spoilage and preserve storage of such meat products.

2. Related Art

Food preservation is a complicated process that requires both a means of preventing microbial contamination and a means of preventing the development of off-colors or off-flavors rendering the food unpalatable. Indeed, off-odor and off-flavor development during refrigerated and frozen storage of fish products is a major obstacle to consumer acceptance. The USDA estimates that more than 96 billion pounds of food in the U.S. were lost by retailers, foodservice, and consumers in 1995, and meat, poultry and fish made up 8.5% of that number—over 8 billion pounds.

Lipid oxidation is the process that causes the formation of stale and rancid odors/flavors that are undesirable. Lipid oxidation is more problemtic in fish compared to beef, pork and poultry, in part due to the higher content of highly unsaturated fatty acids in fish muscle. Heme proteins in fish muscle also promote lipid oxidation much more rapidly compared to those in the terrestrial animals. Any process or food additive that can improve the shelf life of meat, particularly fish, by only two days (during refrigerated storage) is of great commercial interest.

### SUMMARY OF THE INVENTION

Thus, in accordance with the present invention, there is provided a method of improving storage life of intact muscle tissue comprising contacting the tissue with active phospholipase A2 (PLA2) enzyme. The PLA2 enzyme may be contacted at a concentration of no more than about 5 mg/kg, at a concentration of no more than about 2.5 mg/kg, at a concentration of no more than about 1 mg/kg, at a concentration of no more than about 0.7 mg/kg, at a concentration of no more than about 0.5 mg/kg, at a concentration of no more than about 0.25 mg/kg or at a concentration of no more than about 0.1 mg/kg. The PLA2 enzyme may be contacted at a concentration of between about 0.1 mg/kg and about 5 mg/kg or at a concentration of between about 0.25 mg/kg and about 2.5 mg/kg. The muscle tissue may be selected from avian tissue, fish tissue, shellfish tissue, pork tissue, beef tissue, bison tissue, mutton tissue, pork tissue, elk tissue, deer tissue, rabbit tissue, reptile tissue or amphibian tissue. The muscle tissue may be cooked or cured muscle tissue, or uncooked and uncured.

The method may further comprising freezing the muscle tissue. The muscle tissue may be treated at 0 to 6° C., including but not limited to using of ice cold PLA2 solution. The muscle may be treated substantially in the absence of exogenous calcium. The muscle may contain hemoglobin at levels that are 80% of fresh unstored tissue 2, 3, 4, 5, 6, 7, 8, 9 or 10 days following treatment. The muscle may remain palatable at 0.6° C. for 2, 3, 4, 5, 6, 7, 8, 9 or 10 days beyond the date upon which untreated muscle cell would no longer be palatable.

Also provided is a storage-stable muscle tissue comprising exogenous active phospholipase A2 (PLA2) enzyme at no more than about 5 mg/kg. The tissue may comprise no more than about 2.5 mg/kg of PLA2 enzyme, no more than about 1 mg/kg of PLA2 enzyme, no more than about 0.7 mg/kg of PLA2 enzyme, no more than about 0.5 mg/kg of PLA2 enzyme, no more than about 0.25 mg/kg of PLA2 enzyme, no more than about 0.1 mg/kg of PLA2 enzyme, no more than about 0.05 mg/kg of PLA2, no more than about 0.01 mg/kg of PLA2 or no more than about 0.005 mg/kg of PLA2. The tissue may comprise between about 0.005 mg/kg and about 5 mg/kg or between about 0.1 mg/kg and about 2.5 mg/kg. The muscle tissue may be selected from avian tissue, fish tissue, shellfish tissue, pork tissue, beef tissue, bison tissue, mutton tissue, pork tissue, elk tissue, deer tissue, rabbit tissue, reptile tissue or amphibian tissue.

In another embodiment, there is provided a method of processing meat comprising (a) preparing a raw meat product from an animal, fish or fowl carcass; (b) treating the raw meat product with active phospholipase A2 (PLA2) enzyme); and (c) packaging the meat product for sale. The method may further comprising contacting the raw meat product with at least one additional preservation agent prior to step (c). The method may further comprise washing the raw meat product before, after or both before and after step (b). Step (b) may comprise treatment at −20 to 6° C. The meat product of step (c) may comprise no more than about 5 mg/kg exogenous PLA2 enzyme. The muscle may contain hemoglobin at levels that are 80% of fresh unstored tissue.

It is contemplated that any method or composition described herein can be implemented with respect to any other method or composition described herein.

The use of the word “a” or “an” when used in conjunction with the term “comprising” in the claims and/or the specification may mean “one,” but it is also consistent with the meaning of “one or more,” “at least one,” and “one or more than one.” The word “about” means plus or minus 5% of the stated number.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE FIGURES

The following drawings form part of the present specification and are included to further demonstrate certain aspects of the present invention. The invention may be better understood by reference to one or more of these drawings in combination with the detailed description of the invention that follows.

FIG. 1—PLA2 maintains redness (compared to control without PLA2) during storage of minced, cod muscle treated with hemoglobin to facilitate lipid oxidation. Effectiveness was observed at concentrations as low as 1.84 mg/kg.

FIG. 2—PLA2 inhibits lipid oxidation (compared to control without PLA2) during storage of washed cod muscle treated with hemoglobin to facilitate lipid oxidation. Effectiveness was observed at concentrations as low as 0.7 mg/kg.

FIG. 3—PLA2 inhibits lipid oxidation (compared to control without PLA2) during storage of cod muscle treated with hemoglobin to facilitate lipid oxidation. Effectiveness was observed at concentrations as low as 1.84 mg/kg.

FIG. 4—Thiobarbituric acid reactive substance (TBARS) values in whitefish fillets dipped in 10 ppm PLA2 (antioxidant) and control (water) during 2° C. storage on ice for 9 days (pH 6.7).

FIG. 5—Lipid peroxide values in whitefish fillets dipped in 10 ppm PLA2 (antioxidant) and control (water) during 2° C. storage on ice for 9 days (pH 6.7).

### DESCRIPTION OF ILLUSTRATIVE EMBODIMENTS

As stated above, lipid oxidation is a major problem in muscle foods and animal tissues used in pet food and rendering industries. The inventors tested a commercial source of porcine phospholipase A2 (PLA2) as an inhibitor of lipid oxidation in washed cod muscle containing added hemoglobin as an oxidant. A usage level of 0.00007% PLA2 prevented lipid oxidation during 7 days of iced storage in washed cod muscle containing added hemoglobin as an oxidant. This is equivalent to 700 mg protecting 1000 kilograms of muscle food. It is envisioned that PLA2 preparations could be used to inhibit lipid oxidation in all types of meats, fish, pet food, and rendered animal tissues since residual hemoglobin and cellular membranes are present in the “animal tissue” materials that are utilized during manufacturing.

### I. PLA2

A. General

Phospholipases A2 (PLA2s) are enzymes that release fatty acids from the second carbon group of glycerol. PLA2s contain about 120 amino acids, are non-glycosylated and water-soluble. This particular phospholipase specifically recognizes the sn-2 acyl bond of phospholipids and catalytically hydrolyzes the bond releasing arachidonic acid (or another fatty acid at the sn-2 position) and lysophospholipids. Upon downstream modification by cyclooxygenases, arachidonic acid is modified into active compounds called eicosanoids. Eicosanoids include prostaglandins and leukotrienes, which are categorized as inflammatory mediators.

PLA2 are commonly found in mammalian tissues as well as insect and snake venom. Venom from both snakes and insects is largely composed of melittin, which is a stimulant of PLA2. Due to the increased presence and activity of PLA2 resulting from a snake or insect bite, arachidonic acid is released from the phospholipid membrane disproportionately. As a result, inflammation and pain occur at the site. There are also prokaryotic A2 phospholipases. Additional types of phospholipases include phospholipase A1, phospholipase B, phospholipase C, and phospholipase D.

Phospholipases A2 include several unrelated protein families with common enzymatic activity. Two most notable families are secreted and cytosolic phospholipases A2. Other families include Ca²⁺ independent PLA2 (iPLA2) and lipoprotein-associated PLA2s (lp-PLA2), also known as platelet activating factor acetylhydrolase (PAF-AH).

Secreted Phospholipases A2 (sPLA2).

The extracellular forms of phospholipases A2 have been isolated from different venoms (snake, bee, and wasp), from virtually every studied mammalian tissue (including pancreas and kidney) as well as from bacteria. They require Ca²⁺ for activity.

Pancreatic sPLA2 serve for the initial digestion of phospholipid compounds in dietary fat. Venom phospholipases help to immobilize prey by promoting cell lysis. In mice, group III sPLA2 are involved in sperm maturation, and group X are thought to be involved in sperm capacitation.

sPLA2 has been shown to promote inflammation in mammals by catalyzing the first step of the arachidonic acid pathway by breaking down phospholipids, resulting in the formation of fatty acids including arachidonic acid. This arachidonic acid is then metabolized to form several inflammatory and thrombogenic molecules. Excess levels of sPLA2 is thought to contribute to several inflammatory diseases, and has been shown to promote vascular inflammation correlating with coronary events in coronary artery disease and acute coronary syndrome, and possibly leading to acute respiratory distress syndrome and progression of Tonsillitis in children. In mice, excess levels of sPLA2 have been associated with inflammation thought to exacerbate asthma and ocular surface inflammation (dry eye).

Increased sPLA2 activity is observed in the cerebrospinal fluid of humans with Alzheimer's disease and Multiple Sclerosis, and may serve as a marker of increases in permeability of the blood-cerebrospinal fluid barrier.

Cytosolic Phospholipases A2 (cPLA2).

The intracellular PLA2 phospholipases are also Ca-dependent, but they have completely different 3D structure and significantly larger than secreted PLA2 (more than 700 residues). They include a C2 domain and large catalytic domain. These phospholipases are involved in cell signaling processes, such as inflammatory response. The produced arachidonic acid is both a signaling molecule and the precursor for other signalling molecules termed eicosanoids. These include leukotrienes and prostaglandins. Some eicosanoids are synthesized from diacylglycerol, released from the lipid bilayer by phospholipase C (see below).

Lipoprotein-Associated PLA2s (lp-PLA2).

Increased levels of lp-PLA2 are associated with cardiac disease, and may contribute to atherosclerosis.

Mechanism.

The suggested catalytic mechanism of pancreatic sPLA2 is initiated by a His-48/Asp-99/calcium complex within the active site. The calcium ion polarizes the sn-2 carbonyl oxygen while also coordinating with a catalytic water molecule, w5. His-48 improves the nucleophilicity of the catalytic water via a bridging second water molecule, w6. It has been suggested that two water molecules are necessary to traverse the distance between the catalytic histidine and the ester. The basicity of His-48 is thought to be enhanced through hydrogen bonding with Asp-99. An asparagine substitution for His-48 maintains wild-type activity, as the amide functional group on asparagine can also function to lower the pKa, or acid dissociation constant, of the bridging water molecule. The rate limiting state is characterized as the degradation of the tetrahedral intermediate composed of a calcium coordinated oxyanion. The role of calcium can also be duplicated by other relatively small cations like cobalt and nickel.

PLA2 can also be characterized as having a channel featuring a hydrophobic wall in which hydrophobic amino acid residues such as Phe, Leu, and Tyr serve to bind the substrate. Another component of PLA2 is the seven disulfide bridges that are influential in regulation and stable protein folding.

Regulation.

Due to the importance of PLA2 in inflammatory responses, regulation of the enzyme is essential. PLA2 is regulated by phosphorylation and calcium concentrations. PLA2 is phosphorylated by a MAPK at Serine-505. When phosphorylation is coupled with an influx of calcium ions, PLA2 becomes stimulated and can translocate to the membrane to begin catalysis. Phosphorylation of PLA2 may be a result of ligand binding to receptors, including 5-HT2 receptors, mGLUR1, bFGF receptor, IFN-α receptor and IFN-γ receptor. In the case of an inflammation, the application of glucocorticoids will stimulate the release of the protein lipocortin which will inhibit PLA2 and reduce the inflammatory response.

In normal brain cells, PLA2 regulation accounts for a balance between arachidonic acid's conversion into proinflammatory mediators and its reincorporation into the membrane. In the absence of strict regulation of PLA2 activity, a disproportionate amount of proinflammatory mediators are produced. The resulting induced oxidative stress and neuroinflammation is analogous to neurological diseases such as Alzheimer's disease, epilepsy, multiple sclerosis, ischemia. Lysophospholipids are another class of molecules released from the membrane that are upstream predecessors of platelet activating factors (PAF). Abnormal levels of potent PAF are also associated with neurological damage. An optimal enzyme inhibitor would specifically target PLA2 activity on neural cell membranes already under oxidative stress and potent inflammation. Thus, specific inhibitors of brain PLA2 could be a pharmaceutical approach to treatment of several disorders associated with neural trauma.

Increase in phospholipase A2 activity is an acute-phase reaction that rises during inflammation, which is also seen to be exponentially higher in low back disc herniations compared to rheumatoid arthritis. It is a mixture of inflammation and substance P that are responsible for pain. Increased phospholipase A2 has also been associated with neuropsychiatric disorders such as schizophrenia and pervasive developmental disorders (such as autism), though the mechanisms involved are not known.

B. Function in Muscle Tissue

There have been a number of reports regarding the ability of PLA2 to treat meat tissue products going back several decades. In 1969, Catell and Bishop (J. Fish Res. Bd. Can., 26, 299-309, 1969) tested very high levels of PLA2 (1000 mg/kg) in cod muscle paper that had added hemoglobin (to promote spoilage. This is far more than the levels disclosed here.

In 1976, Mazeaud and Bilinski (J. Fish Res. Bd. Can., 33, 1297-1302, 1976) used an indeterminate amount but the dose was likely much higher than that used here since they estimated that 20-50% of the total fatty acids at position 2 were hydrolyzed. In any event, PLA2 efficacy was weak during 4° C. storage. Efficacy was better during 2 h of 37° C. storage, but this is not a practical temperature for storing fish muscle.

In 1977, Godvindarajan et al. (J. Food Sci., 42, 571-577, 1977) used PLA2 at 0.66 mgm % in beef. Again, this is no easily converted to mg/kg, but the authors stated effects due to this level of PLA2 were “not very large” and trended towards inhibiting lipid oxidation and inhibiting loss of red color.

In 1981, Shewfelt's review (J. Food Chem., 5, 79-100, 1981) mentions a flounder microsome paper in which PLA2 addition was 1000 mg/kg sample, and this in fact would represent an even higher level was used since isolated microsomes is far more concentrated in lipid than muscle (J. Food Sci., 46, 1297-1301, 1981). The 1983 Shewfelt and Hultin paper (Biochemica et Biophyica Acta, 751, 432-438, 1983) used 10 mg/kg in fish membranes, but again, isolated membranes are not comparable to intact muscle tissue. In sum, the 1981 Shewfelt review paper states free fatty acid formation (due to lipases and/or phospholipases) increases quality deterioration in some cases (8 cited references), while other studies point in the opposite direction (8 cited references). Shewfelt then surmised that phospholipases are antioxidative and lipases are pro-oxidative, but the evidence clearly was mixed.

C. Production

The enzyme can be extracted from animal byproducts. Stomach tissue is particularly rich in PLA2 compared to other animal tissues (Tojo et al., J. Lipid Res. 34, 837-844 1993). A two step chromatographic procedure using stomach tissue has been used that may be feasible with scale up (Tojo et al., Eur. J. Biochem. 215, 81-90, 1993). The bottle of commercial porcine PLA2 we obtained contained 1,255 mg protein. The cost to purchase that bottle could not be retrieved but suggests manufacturing should be relatively low cost.

Bacterial fermentation is also a potential source of PLA2. There is a GRAS notice to use endogenous PLA2 from Streptomyces violaceruber to hydrolyze egg yolk lecithins (GRAS notice 212). PLA2s contain about 120 amino acids. PLA2 is non-glycosylated and water-soluble which should produce high yield and facile purification from a bacterial host. There is a GRAS notice to use Aspergillus niger to express a gene encoding a porcine phospholipase A2 in bread dough, bakery, and egg-yolk based products (GRAS notice 183).

### II. MEAT PROCESSING

Meat is produced by killing an animal and cutting flesh out of it. These procedures are called slaughter and butchery, respectively. The general process for preparing meat for consumption involves the steps of transport, slaughter, dressing & cutting, conditioning, treatment with additives, preservation and packaging. These steps are described below.

A. Transport

Upon reaching a predetermined age or weight, livestock are usually transported en masse to the slaughterhouse. Depending on its length and circumstances, this may exert stress and injuries on the animals, and some may die en route. Unnecessary stress in transport may adversely affect the quality of the meat. In particular, the muscles of stressed animals are low in water and glycogen, and their pH fails to attain acidic values, all of which results in poor meat quality. Consequently, and also due to campaigning by animal welfare groups, laws and industry practices in several countries tend to become more restrictive with respect to the duration and other circumstances of livestock transports.

B. Slaughter

Animals are usually slaughtered by being first stunned and then exsanguinated (bled out). Death results from the one or the other procedure, depending on the methods employed. Stunning can be effected through asphyxiating the animals with carbon dioxide, shooting them with a gun or a captive bolt pistol, or shocking them with electric current. In most forms of ritual slaughter, stunning is not allowed.

Draining as much blood as possible from the carcase is necessary because blood causes the meat to have an unappealing appearance and is a very good breeding ground for microorganisms. The exsanguination is accomplished by severing the carotid artery and the jugular vein in cattle and sheep, and the anterior vena cava in pigs.

C. Dressing & Cutting

After exsanguination, the carcase is dressed; that is, the head, feet, hide (except hogs and some veal), excess fat, viscera and offal are removed, leaving only bones and edible muscle. Cattle and pig carcases, but not those of sheep, are then split in half along the mid ventral axis, and the carcase is cut into wholesale pieces. The dressing and cutting sequence, long a province of manual labor, is progressively being fully automated.

D. Conditioning

Under hygienic conditions and without other treatment, meat can be stored at above its freezing point (−1.5° C.) for about six weeks without spoilage, during which time it undergoes an aging process that increases its tenderness and flavor.

During the first day after death, glycolysis continues until the accumulation of lactic acid causes the pH to reach about 5.5. The remaining glycogen, about 18 g per kg, is believed to increase the water-holding capacity and tenderness of the flesh when cooked. Rigor mortis sets in a few hours after death as ATP is used up, causing actin and myosin to combine into rigid actomyosin and lowering the meat's water-holding capacity, causing it to lose water (“weep”). In muscles that enter rigor in a contracted position, actin and myosin filaments overlap and cross-bond, resulting in meat that is tough on cooking—hence again the need to prevent pre-slaughter stress in the animal.

Over time, the muscle proteins denature in varying degree, with the exception of the collagen and elastin of connective tissue, and rigor mortis resolves. Because of these changes, the meat is tender and pliable when cooked just after death or after the resolution of rigor, but tough when cooked during rigor. As the muscle pigment myoglobin denatures, its iron oxidates, which may cause a brown discoloration near the surface of the meat. Ongoing proteolysis also contributes to conditioning. Hypoxanthine, a breakdown product of ATP, contributes to the meat's flavor and odor, as do other products of the discomposition of muscle fat and protein.

E. Treatment with Additives

When meat is industrially processed in preparation of consumption, it may be enriched with additives to protect or modify its flavor or color, to improve its tenderness, juiciness or cohesiveness, or to aid with its preservation. Meat additives include the following:
Salt is the most frequently used additive in meat processing. It imparts flavor but also inhibits microbial growth, extends the product's shelf life and helps emulsifying finely processed products, such as sausages. Ready-to-eat meat products normally contain about 1.5 to 2.5 percent salt.
Nitrite is used in curing meat to stabilize the meat's color and flavor, and inhibits the growth of spore-forming microorganisms such as C. botulinum. The use of nitrite's precursor nitrate is now limited to a few products such as dry sausage, prosciutto or parma ham.
Phosphates used in meat processing are normally alkaline polyphosphates such as sodium tripolyphosphate. They are used to increase the water-binding and emulsifying ability of meat proteins, but also limit lipid oxidation and flavor loss, and reduce microbial growth.
Erythorbate or its equivalent ascorbic acid (vitamin C) is used to stabilize the color of cured meat.
Sweeteners such as sugar or corn syrup impart a sweet flavor, bind water and assist surface browning during cooking in the Maillard reaction.
Seasonings impart or modify flavor. They include spices or oleoresins extracted from them, herbs, vegetables and essential oils.
Flavorings such as monosodium glutamate impart or strengthen a particular flavor.
Tenderizers break down collagens to make the meat more palatable for consumption. They include proteolytic enzymes, acids, salt and phosphate.
Dedicated antimicrobials include lactic, citric and acetic acid, sodium diacetate, acidified sodium chloride or calcium sulfate, cetylpyridinium chloride, activated lactoferrin, sodium or potassium lactate, or bacteriocins such as nisin.
Antioxidants include a wide range of chemicals that limit lipid oxidation, which creates an undesirable “off flavor,” in precooked meat products.
Acidifiers, most often lactic or citric acid, can impart a tangy or tart flavor note, extend shelf-life, tenderize fresh meat or help with protein denaturation and moisture release in dried meat. They substitute for the process of natural fermentation that acidifies some meat products such as hard salami or prosciutto.

F. Preservation

The spoilage of meat occurs, if untreated, in a matter of hours or days and results in the meat becoming unappetizing, poisonous or infectious. Spoilage is caused by the practically unavoidable infection and subsequent decomposition of meat by bacteria and fungi, which are borne by the animal itself, by the people handling the meat, and by their implements. Meat can be kept edible for a much longer time—though not indefinitely—if proper hygiene is observed during production and processing, and if appropriate food safety, food preservation and food storage procedures are applied. Without the application of preservatives and stabilizers, the fats in meat may also begin to rapidly decompose after cooking or processing, leading to an objectionable taste known as warmed over flavor.

### III. PRESERVATION COMPOSITIONS

In accordance with the present invention, the use of PLA2 is envisioned for the purpose preserving meats and rendering them more stable during storage. One of the improvements provided by the present invention is the use of low concentration PLA2 compositions. It is envisioned that one will dilute PLA2 enzyme in an appropriate buffered solution and applied to a meat product in an amount to provide no more than about or at about 5 PLA2 mg/kg of meat. Also contemplated are amounts, and approximate upper limits, of about 2.5 mg/kg of PLA2 enzyme, about 1 mg/kg of PLA2 enzyme, about 0.7 mg/kg of PLA2 enzyme, about 0.5 mg/kg of PLA2 enzyme, about 0.25 mg/kg of PLA2 enzyme or about 0.1 mg/kg of PLA2 enzyme. Specific ranges include about 0.1 mg/kg to about 5 mg/kg, about 0.25 mg/kg to about 2.5 mg/kg, about 0.1 mg/kg to about 0.25 mg/kg and 0.25 mg/kg to about 0.5 mg/kg. PLA2 is water soluble which will allow it to be easily incorporated into muscle tissues.

Food grade buffers (sodium, potassium, acetates, gluconates) and protein stabilizers may be used to stabilize pH of the solution and maintain protein structure during storage of the PLA2 solution before adding the solution to muscle tissues.

### IV. METHODS OF PRESERVING MUSCLE TISSUE

Surface applications are envisioned for specific cuts of meat and fish (e.g., beef steaks, pork chops, fish fillets). A fine mist of the PLA2 solution will be added to surfaces prior to raw storage. For ground products (e.g., fresh pork sausage) the PLA2 solution can be incorporated during mixing of raw materials and dry ingredients with the 3% allowable water in this meat category. Mechanically separated poultry (MSP) is often treated with about 0.05% antioxidant solution or dispersion (weight to weight). PLA2 will be concentrated for use in MSP so that the desired concentration of PLA2 is provided in a 0.05% solution (weight to weight). For relatively large pieces of meat that are to be cooked intact and then shredded after cooking (e.g., pulled pork), the PLA2 solution will be included in the brine that is injected prior to cooking. There is some evidence that PLA2 is stable at cooking temperatures so it may not be necessary to delay thermal processing after injecting the PLA2 solution. Ice cold solutions of PLA2 will be used in all cases. Ice-cold temperature is common practice during addition of solutions to meat raw materials. Effort will not be undertaken to remove PLA2 after addition to muscle tissues since very low concentrations will be used. It is also possible that the added PLA2 solution is acting on muscle phospholipids on a scale of minutes to days post-application so that removal soon after application may limit effectiveness at the low concentrations used.

### V. MEAT PRODUCTS FOR PRESERVATION

A. Meat Tissues

The present invention may be applied to virtually any meat product. Examples include avian tissue, amphibian tissue (frog), fish tissue, shellfish tissue, and red meat. Red meat includes pork tissue, beef tissue, bison tissue, mutton tissue, elk tissue, deer tissue, rabbit tissue. Avian tissue includes quail, chicken, dove, turkey, or ostrich. Shellfish tissue includes lobster, shrimp, crab, prawn, crawfish and molluscs (squid, octopus). Fish tissue includes capelin, cod, flounder, grouper, halibut, swordfish, mahi mahi, salmon, redfish, sole, whitefish, tuna, amberjack, char, sea bass, striped bass, sunfish, crappie, catfish, bream, turbot, snapper, carp, chub, drum, haddock, hake, herring, mackerel, monkfish, mullet, rockfish, pollock, pompano, pufferfish, sardine, scrod, skate, sturgeon, tilapia, welk, and whiting. Another fish product is fish eggs, such as caviar.

B. Pet Food

Pet food is plant or animal material intended for consumption by pets. Typically sold in pet stores and supermarkets, it is usually specific to the type of animal, such as dog food or cat food. Most meat used for nonhuman animals is a byproduct of the human food industry, and is not regarded as “human grade.” Four companies—Procter & Gamble, Nestlé, Mars, and Colgate-Palmolive—are thought to control 80% of the world's pet-food market, which in 2007 amounted to US$ 45.12 billion for cats and dogs alone.

Some types of pet foods—particularly those for dogs and cats—use meat products. Indeed, cats are obligate carnivores, though most commercial cat food contains both animal and plant material supplemented with vitamins, minerals and other nutrients. While recommendations differ on what diet is best for dogs, some form of meat product is included in the food bet that dry form, also known as kibble, or wet, canned form. Also, raw feeding is the practice of feeding domestic dogs and cats a diet consisting primarily of uncooked meat and bones. Supporters of raw feeding believe the natural diet of an animal in the wild is its most ideal diet and try to mimic a similar diet for their domestic companions.

C. Rendered Products

Edible rendering processes are basically meat processing operations and produce lard or edible tallow for use in food products. Edible rendering is generally carried out in a continuous process at low temperature (less than the boiling point of water). The process usually consists of finely chopping the edible fat materials (generally fat trimmings from meat cuts), heating them with or without added steam, and then carrying out two or more stages of centrifugal separation. The first stage separates the liquid water and fat mixture from the solids. The second stage further separates the fat from the water. The solids may be used in food products, pet foods, etc., depending on the original materials. The separated fat may be used in food products, or if in surplus, it may be diverted to soap making operations. Most edible rendering is done by meat packing or processing companies.

One edible product is greaves, which is the unmeltable residue left after animal fat has been rendered. An alternative process cooks slaughterhouse offal to produce a thick, lumpy “stew” which is then sold to the pet food industry to be used principally as tinned cat and dog foods. Such plants are notable for the offensive odour that they can produce and are often located well away from human habitation.

Materials that for aesthetic or sanitary reasons are not suitable for human food are the feedstocks for inedible rendering processes. Much of the inedible raw material is rendered using the “dry” method. This may be a batch or a continuous process in which the material is heated in a steam-jacketed vessel to drive off the moisture and simultaneously release the fat from the fat cells. The material is first ground, then heated to release the fat and drive off the moisture, percolated to drain off the free fat, and then more fat is pressed out of the solids, which at this stage are called “cracklings” or “dry-rendered tankage.” The cracklings are further ground to make meat and bone meal. A variation on a dry process involves finely chopping the material, fluidizing it with hot fat, and then evaporating the mixture in one or more evaporator stages. Some inedible rendering is done using a wet process, which is generally a continuous process similar in some ways to that used for edible materials. The material is heated with added steam and then pressed to remove a water-fat mixture which is then separated into fat, water and fine solids by stages of centrifuging and/or evaporation. The solids from the press are dried and then ground into meat and bone meal. Most independent renderers process only inedible material.

Any of the aforementioned rendered products may be treated in accordance with the present invention to improve stability.

### VI. Examples

The following examples are included to demonstrate particular embodiments of the invention. It should be appreciated by those of skill in the art that the techniques disclosed in the examples which follow represent techniques discovered by the inventor to function well in the practice of the invention, and thus can be considered to constitute particular modes for its practice. However, those of skill in the art should, in light of the present disclosure, appreciate that many changes can be made in the specific embodiments which are disclosed and still obtain a like or similar result without departing from the spirit and scope of the invention.

### Example 1

### Materials and Methods

Effectiveness of PLA2 was demonstrated in minced, cod muscle treated with added hemoglobin (Hb) that promotes lipid oxidation during iced storage. PLA2 solutions of varying concentration were added to the cod muscle 30 minutes to 2 hours prior to addition of Hb. The control sample was treated with deionized water instead of PLA2 solution.

A-value is a measure of redness. Maintaining red color during storage of washed cod containing added Hb is consistent with inhibition of lipid oxidation. Loss of a-value is typical when lipid oxidation due to Hb occurs in the absence of added antioxidants (see control sample in FIG. 1) Thiobarbituric acid reactive substances (TBARS) were used as an indicator of lipid oxidation (see FIGS. 2-3).

Washed cod muscle was also examined as a substrate. Washing is done to remove aqueous antioxidants and pro-oxidants that are endogenously present in the cod muscle. Myofibrillar protein and cellular membranes containing phospholipids remain after washing to produce a matrix that closely resembles muscle tissue. Lipid oxidation due to added Hb occurs relatively rapidly in washed cod muscle compared to unwashed cod muscle since aqueous antioxidants endogenous to cod muscle are removed by washing.

### Example 2

### Results

PLA2 maintains redness (compared to control without PLA2) during storage of minced, cod muscle treated with hemoglobin to facilitate lipid oxidation (FIG. 1). Effectiveness was observed at concentrations as low as 1.84 mg/kg. Hemoglobin was added at ca. 40 μM.

FIG. 2 shows that PLA2 inhibits lipid oxidation (compared to control without PLA2) during storage of washed cod muscle treated with hemoglobin to facilitate lipid oxidation. Effectiveness was observed at concentrations as low as 0.7 mg/kg. Hemoglobin was added at ca. 40 μM.

PLA2 inhibits lipid oxidation (compared to control without PLA2) as shown in FIG. 3 during storage of cod muscle treated with hemoglobin to facilitate lipid oxidation. Effectiveness was observed at concentrations as low as 1.84 mg/kg. Hemoglobin was added at ca. 40 μM.

FIG. 4 shows that “dipping” whitefish fillets in 10 ppm pure PLA2 solution was effective at inhibiting lipid oxidation. Given that 2.5% moisture pick up occurs when dipping intact pieces, a value of 0.25 mg PLA2/kg whitefish fillets (efficacy at 0.25 ppm) is obtained.

The antioxidant mechanism in whitefish fillets appears to be due to removal of lipid hydroperoxides (LOOH) that form in the muscle during storage (FIG. 5). This can explain the effectiveness of PLA2 at low ppm levels. Even though the total fat content is 4% of the fillet weight, the maximal LOOH value was 400 μmol/kg, which is 0.01-0.03% of the fillet weight. Thus the enzyme appears to stabilize the most labile lipids that are present in trace amounts.

Table 1 shows color stability, lipid oxidation and free fatty acid data in minced pork at day 4 of light display at 34° F. (1° C.) (semitendinosus muscle). The a-value represents redness which is desirable during light display of raw product. A one unit difference in (a-value) is detectable by eye so this is a substantial difference in redness. TBARS, a marker of lipid oxidation, are also lower in the PLA2 containing sample. Elevated free fatty acid level in PLA2-containing samples is indicative of PLA2 action.

TABLE 1
Redness, TBARS, and free fatty acid values at day 4 and
day 6 in minced pork during light display at 1° C. (34° F.)

| | Redness | TBARS value | Free fatty acid |
|---|---|---|---|
| | (a-value) | μmol/kg tissue | μmol/g tissue |
| Day 4 | 12.23 | 1.43 | 0.34 |
| Minced pork | | | |
| Day 4 | 14.06 | 1.00 | 0.60 |
| Minced pork + | | | |
| PLA2 5.6 ppm) | | | |
| Day 6 | 11.12 | — | 0.62 |
| Minced pork | | | |
| Day 6 | 13.09 | — | 1.04 |
| Minced pork + | | | |
| PLA2 5.6 ppm) | | | |

### Example 3

### Discussion

The fact that an antioxidant effect of PLA2 is clearly observed in the cod/Hb system as well as whitefish fillets suggests the strongest claims should be made for foods rich in the health promoting omega 3 fatty acids.

Species of fish that are heavily farmed globally and can be stabilized by PLA2 include carp, catfish, sea bream, sea bass, trout and tilapia. Salmon muscle is rich in omega-3 fatty acids and could be a market for PLA2 stabilization. Other wild capture species of fish that contain substantial quantities of omega 3s and can be stabilized by PLA2 include cod, hakes, haddock, flounder, halibut, soles, sardines, capelin, and anchovies. Caviar and other fish egg products are rich in omega 3s and thus can be stabilized by PLA2.

Mackerel and tuna are rich in omega-3 fatty acids. One hurdle preventing use of underutilized fish species such as mackerel and herring in the production of surimi (e.g., imitation crab) is off-flavor due to oxidation of omega-3 fatty acids in the final product. PLA2 should inhibit lipid oxidation in surimi prepared from fish rich in omega-3s.

The aquaculture salmon industry is valued at $11.7 B/year globally and represents 69% of total salmon production (3.4 M tonnes/yr). Tuna production is 4.0 M tonnes/yr. The frozen mackerel value is $1.1 B/yr. These, along with other fish products, represent an enormous market for application of this technology.

PLA2 may also be especially effective in pork and poultry that is enriched in omega 3 fatty acids via the diet. To date, fortification of pork and poultry has been unsuccessful due to formation of off-flavors during storage. PLA2 should act to stabilize the omega-3s in the pork and poultry muscle in a similar fashion to what is observed in fish.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

### VII. REFERENCES

The following references, to the extent that they provide exemplary procedural or other details supplementary to those set forth herein, are specifically incorporated herein by reference:
1. Tojo, H.; Ono, T.; Okamoto, M., J Lipid Res, 34, 837-44, 1993.
2. Tojo, H.; Ying, Z.; Okamoto, M., Eur J Biochem, 215, 81-90, 1993.
3. Catell and Bishop, J. Fish Res. Bd. Can., 26, 299-309, 1969.
4. Mazeaud and Bilinski, J. Fish Res. Bd. Can., 33, 1297-1302, 1976.
5. Godvindarajan et al., J. Food Sci., 42, 571-577, 1977.
6. Shewfelt, J. Food Chem., 5, 79-100, 1981.
7. Shewfelt, J. Food Sci., 46, 1297-1301, 1981.
8. Shewfelt and Hultin, Biochemica et Biophyica Acta, 751, 432-438, 1983.

1. A method of improving storage life of intact muscle tissue comprising contacting said tissue with active phospholipase A2 (PLA2) enzyme.

2. The method of claim 1, wherein said PLA2 enzyme is contacted at a concentration of no more than about 5 mg/kg.

3. The method of claim 1, wherein said PLA2 enzyme is contacted at a concentration of no more than about 2.5 mg/kg.

4. The method of claim 1, wherein said PLA2 enzyme is contacted at a concentration of no more than about 1 mg/kg, no more than about 0.7 mg/kg, no more than about 0.5 mg/kg, no more than about 0.25 mg/kg and no more than about 0.1 mg/kg.

5-8. (canceled)

9. The method of claim 1, wherein said PLA2 enzyme is contacted at a concentration of between about 0.1 mg/kg and about 5 mg/kg.

10. The method of claim 1, wherein said PLA2 enzyme is contacted at a concentration of between about 0.25 mg/kg and about 2.5 mg/kg.

11. The method of claim 1, wherein said muscle tissue is avian tissue, fish tissue, shellfish tissue, amphibian tissue, mammalian tissue, red meat, port.

12-14. (canceled)

15. The method of claim 11, wherein said mammalian tissue is red meat, pork or mutton.

16. The method of claim 15, wherein said red meat is beef or bison meat.

17-18. (canceled)

19. The method of claim 1, wherein said muscle tissue is cooked or cured muscle tissue.

20. The method of claim 1, wherein said muscle tissue is uncooked and uncured.

21. The method of claim 1, further comprising freezing said muscle tissue.

22. The method of claim 1, wherein said muscle tissue is treated at 0 to 6° C.

23. The method of claim 1, wherein said muscle is treated substantially in the absence of exogenous calcium.

24. The method of claim 1, wherein said muscle contains hemoglobin at levels that are 80% of fresh unstored tissue for 2, 3, 4, 5, 6, 7, 8, 9 or 10 days following treatment with PLA2.

25. The method of claim 1, wherein said muscle remains palatable at 0.6° C. for 2, 3, 4, 5, 6, 7, 8, 9 or 10 days beyond the date upon which untreated muscle cell would no longer be palatable.

26. A storage-stable muscle tissue comprising exogenous active phospholipase A2 (PLA2) enzyme at no more than about 5 mg/kg.

27. The muscle tissue of claim 26, wherein said tissue comprises no more than about 2.5 mg/kg of PLA2 enzyme.

28. The muscle tissue of claim 26, wherein said tissue comprises no more than about 1 mg/kg of PLA2 enzyme.

29. The muscle tissue of claim 26, wherein said tissue comprises no more than about 0.7 mg/kg of PLA2 enzyme, no more than about 0.5 mg/kg of PLA2 enzyme, no more than about 0.25 mg/kg of PLA2 enzyme, no more than about 0.1 mg/kg of PLA2 enzyme, no more than about 0.05 mg/kg of PLA2 enzyme, no more than about 0.05 mg/kg of PLA2 enzyme, no more than about 0.01 mg/kg of PLA2 enzyme, or no more than about 0.005 mg/kg of PLA2 enzyme.

30-35. (canceled)

36. The muscle tissue of claim 26, wherein said tissue comprises between about 0.005 mg/kg and about 5 mg/kg.

37. The muscle tissue of claim 26, wherein said tissue comprises between about 0.01 mg/kg and about 2.5 mg/kg.

38. The muscle tissue of claim 26, wherein said tissue comprises between about 0.05 mg/kg and about 1 mg/kg.

39. The muscle tissue of claim 26, wherein said muscle tissue is selected from avian tissue, fish tissue, shellfish tissue, pork tissue, beef tissue, bison tissue, mutton tissue, pork tissue, elk tissue, deer tissue, rabbit tissue, reptile tissue or amphibian tissue.

40. A method of processing meat comprising:
(a) preparing a raw meat product from an animal, fish or fowl carcass;
(b) treating said raw meat product with active phospholipase A2 (PLA2) enzyme); and
(c) packaging said meat product for sale.

41. The method of claim 40, further comprising contacting said raw meat product with at least one additional preservation agent prior to step (c).

42. The method of claim 40, further comprising washing said raw meat product before, after or both before and after step (b).

43. The method of claim 40, wherein step (b) comprises treatment at −20 to 6° C.

44. The method of claim 40, wherein the meat product of step (c) comprises no more than about 5 mg/kg exogenous PLA2 enzyme.

45. The method of claim 40, wherein said meat product comprises muscle tissue is selected from avian tissue, fish tissue, shellfish tissue, pork tissue, beef tissue, bison tissue, mutton tissue, pork tissue, elk tissue, deer tissue, rabbit tissue, reptile tissue or amphibian tissue.
